(19) United States
(12) Patent Application Publication
(10) Pub. No.: US 2026/0043547 A1
(43) Pub. Date: Feb. 12, 2026

(54) COOKING APPLIANCE WITH STEPPER MOTOR ACTIVATED GAS VALVES

(71) Applicant: Midea Group Co., Ltd., Foshan (CN)

(72) Inventors: Felix Conde Zelocuatecatl, Louisville, KY (US); Antonio Lopez Juarez, Louisville, KY (US)

(73) Assignee: Midea Group Co., Ltd., Foshan (CN)

(21) Appl. No.: 18/795,754

(22) Filed: Aug. 6, 2024

(51) Int. Cl. F24C 3/12; F16K 31/04; F23N 1/00

(52) U.S. Cl. CPC F24C 3/122; F16K 31/04; F23N 1/005

(57) ABSTRACT

An electronic control system for a gas cooking appliance utilizes in part a stepper motor to controllably rotate a mechanical gas valve actuator that controls the flow of gas to a gas burner in response to a coded signal generated by a user actuated rotary coded switch, as well as a home position switch that is engaged when the mechanical gas valve actuator is in a closed position to positively verify that gas flow to the gas burner has been shut off.

### BACKGROUND

Cooking appliances such as cooktops and ranges generally rely on a number of user controls for adjusting and controlling the output levels of various burners or cooking elements. Traditionally, many cooking appliances have relied upon rotary user controls such as control knobs, as such user controls have generally found to be relatively simple and efficient to use. For cooking elements that rely on electric power, the user controls are generally coupled to infinite switch arrangements that regulate the switching of bi-metallic switches to control the output levels of the cooking elements, and for cooking elements that rely on gas, the user controls are generally coupled to mechanical valves that vary gas flow to the cooking elements. In both cases, the user controls are effectively mechanical in nature, as mechanical couplings are used between the user controls and the components that regulate the output levels of the cooking elements. Further, simple indicia are often provided on or adjacent to the user controls to indicate the on/off state and output level of each associated cooking element, which while decidedly “low tech,” is still relatively easy to read and understand by most users.

More recently, some cooking appliances have employed electronic control systems to provide a more modern and full-featured user interface, and some, for example, have utilized touch screen displays and/or buttons to implement “soft” user controls to control the output levels of cooking elements. In some gas cooking appliances, for example, electromechanical valves have been used to regulate gas flow to gas cooking elements, with touch screen display-based user controls used to set desired output levels and software-based control to control the electromechanical valves to provide gas flow suitable for the user-selected output levels.

It has been found, however, these electronic control systems, and in particular, the touch screen display-based user controls often utilized in such systems, can be less intuitive than simple rotary user controls, and can present challenges in terms of enabling users to quickly ascertain the current state and output level of a particular cooking element, as well as to turn cooking elements on or off or to vary their output levels. Such electronic control systems are also generally more expensive than corresponding mechanically-based control systems, raising the overall cost of the cooking appliance.

Moreover, one benefit of mechanically-based control systems is that there is generally some assurance that when a user control is in an “off” position, the mechanically-coupled component that regulates the output level of the corresponding cooking element is also in its corresponding off position.

Therefore, a continuing need exists in the art for a reliable and cost-effective manner of electronically controlling gas cooking elements in a cooking appliance.

### SUMMARY

The herein-described embodiments address these and other problems associated with the art by providing an electronic control system for a gas cooking appliance that utilizes in part a stepper motor to controllably rotate a mechanical gas valve actuator that controls the flow of gas to a gas burner in response to a coded signal generated by a user actuated rotary coded switch. The coded signal selects between a plurality of discrete rotational positions of the user actuated rotary coded switch that are in turn mapped to different rotational positions of the mechanical gas valve actuator, such that the stepper motor may be driven to rotate the mechanical gas valve actuator to the rotational position mapped to a currently selected discrete rotational position of the user actuated rotary coded switch. In addition, when the user actuated rotary coded switch is actuated to a discrete rotational position mapped to a closed position of the mechanical gas valve actuator, a home position switch is engaged when the mechanical gas valve actuator reaches the closed position to positively verify that gas flow to the gas burner has been shut off.

Therefore, consistent with one aspect of the invention, a cooking appliance may include a gas burner, a mechanical gas valve coupling the gas burner to a gas supply, the mechanical gas valve including a valve actuator rotatable between a closed position and an open position to regulate an output level of the gas burner, where when in the closed position the valve actuator shuts off a supply of gas to the gas burner, a stepper motor mechanically coupled to the valve actuator and configured to controllably rotate the valve actuator between the closed and open positions, a home position switch configured to be mechanically engaged to indicate when the valve actuator is rotated to the closed position, a rotary coded switch rotatable between a plurality of discrete rotational positions and configured to output a coded signal indicating a current discrete rotational position among the plurality of discrete rotational positions, the plurality of discrete rotational positions including an off discrete rotational position, and a control circuit coupled to the stepper motor, the home position switch, and the rotary coded switch and configured to control the stepper motor to rotate the valve actuator to a first predetermined position in response to selection of a first discrete rotational position among the plurality of discrete rotational positions of the rotary coded switch to control the output level of the gas burner, to control the stepper motor to rotate the valve actuator to the closed position in response to selection of the off discrete rotational position of the rotary coded switch, and to access the home position switch after controlling the stepper motor to rotate the valve actuator to the closed position to verify closure of the mechanical gas valve.

In some embodiments, the stepper motor includes a shaft that is coaxial with and mechanically couples with the valve actuator. Also, in some embodiments, the mechanical gas valve includes a valve body including a slot, and the home position switch is coupled to the valve body and includes an actuator that projects into the slot. Further, in some embodiments, the actuator of the home position switch includes a depressible plunger.

Some embodiments may further include a cam member operably coupled to the valve actuator to rotate with the valve actuator within an interior of the valve body, the cam member further configured to actuate the actuator of the home position switch when the valve actuator is in the closed position. In some embodiments, the valve body further includes first and second internal stops disposed in a path of rotation of the cam member to limit rotation of the valve actuator between the closed position and a minimum operational output position. In addition, in some embodiments, the home position switch is a normally open switch that is closed when the valve actuator is rotated to the closed position.

In some embodiments, the rotary coded switch outputs a Gray code when rotating between the plurality of discrete rotational positions. In addition, in some embodiments, the rotary coded switch includes a plurality of detents, each configured to maintain the rotary coded switch at a respective discrete rotational position of the plurality of discrete rotational positions.

In addition, some embodiments may further include a rotary burner control, the rotary burner control including a rotary control actuator coupled to the rotary coded switch to rotate the rotary coded switch in response to user input. In some embodiments, the rotary control actuator is coupled to the rotary code switch through an adapter that is movable along an axial direction relative to an axis of rotation of the rotary coded switch and biased away from switch. Moreover, in some embodiments, the adapter is configured to engage a support of the rotary burner control when the rotary coded switch is in the off discrete rotational position and the adapter is biased away from the rotary coded switch to restrict rotation of the rotary control actuator away from the off discrete rotational position, and the adapter is further configured to disengage from the support when the rotary control actuator is pushed toward the rotary coded switch to permit rotation of the rotary control actuator away from the off discrete rotational position.

Some embodiments may also include a main gas valve coupled in series with the mechanical gas valve and configured to regulate a flow of gas from a gas supply to the mechanical gas valve, and the control circuit is further coupled to the main gas valve and is configured to, during a cooking operation, maintain the main gas valve in an open position while controlling the stepper motor to control the output level of the gas burner. In addition, some embodiments may also include an ignition module configured to ignite the gas burner while gas is supplied to the gas burner through the mechanical gas valve. In some embodiments, the ignition module is a reignition module and is configured to attempt to automatically reignite the gas burner in response to detecting a flame loss.

Moreover, in some embodiments, the control circuit maps each of the plurality of discrete rotational positions of the rotary coded switch to a predetermined position of the valve actuator such that, in response to rotation of the rotary coded switch to a first discrete rotational position of the plurality of rotational positions, the control circuit controls the stepper motor to rotate the valve actuator to a first predetermined position mapped to the first discrete rotational position of the rotary coded switch. Also, in some embodiments, the control circuit includes a programmable controller configured to operate the stepper motor to controllably rotate the valve actuator between at least two rotational positions during a cooking operation while the rotary coded switch is maintained in a first discrete rotational position.

In some embodiments, the at least two rotational positions include a first rotational position suitable for igniting the gas burner, and a second rotational position corresponding to a desired output level of the gas burner during the cooking operation.

In addition, in some embodiments, the programmable controller is further configured to control the stepper motor to automatically close the mechanical gas valve after a predetermined time. Also, in some embodiments, the control circuit further includes a network interface configured to communicate with an external device, and the programmable controller is further configured to control the stepper motor to automatically close the mechanical gas valve in response to user input from the external device.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a cooking appliance consistent with some embodiments of the invention.

FIG. 2 is a block diagram of an example electronic control system for the cooking appliance of FIG. 1.

FIG. 3 is a chart of an example code signal output by the rotary coded switch referenced in FIG. 2.

FIG. 4 is a front side perspective view of an example rotary burner control of the cooking appliance of FIG. 1.

FIG. 5 is an exploded front side perspective view of the rotary burner control of FIG. 4.

FIG. 6 is an exploded rear side perspective view of the rotary burner control of FIG. 4.

FIG. 7 is a front side perspective view of an example valve assembly of the cooking appliance of FIG. 1.

FIG. 8 is an exploded front side perspective view of the valve assembly of FIG. 7.

FIG. 9 is a cross-sectional view of the valve assembly of FIG. 7, taken along lines 9-9 thereof.

FIG. 10 is a block diagram of an example electronic board of the electronic control system of FIG. 2.

FIG. 11 is a timing diagram illustrating operation of the electronic control system of FIG. 2.

### DETAILED DESCRIPTION

In the embodiments discussed hereinafter, a gas cooking appliance may utilize a reliable and cost-effective electronic control system to control one or more gas burners in the cooking appliance. In some embodiments, the electronic control system for a gas cooking appliance utilizes in part a stepper motor to controllably rotate a mechanical gas valve actuator that controls the flow of gas to a gas burner in response to a coded signal generated by a user actuated rotary coded switch. The coded signal selects between a plurality of discrete rotational positions of the user actuated rotary coded switch that are in turn mapped to different rotational positions of the mechanical gas valve actuator, such that the stepper motor may be driven to rotate the mechanical gas valve actuator to the rotational position mapped to a currently selected discrete rotational position of the user actuated rotary coded switch. In addition, when the user actuated rotary coded switch is actuated to a discrete rotational position mapped to a closed position of the mechanical gas valve actuator, a home position switch is engaged when the mechanical gas valve actuator reaches the closed position to verify that gas flow to the gas burner has been shut off.

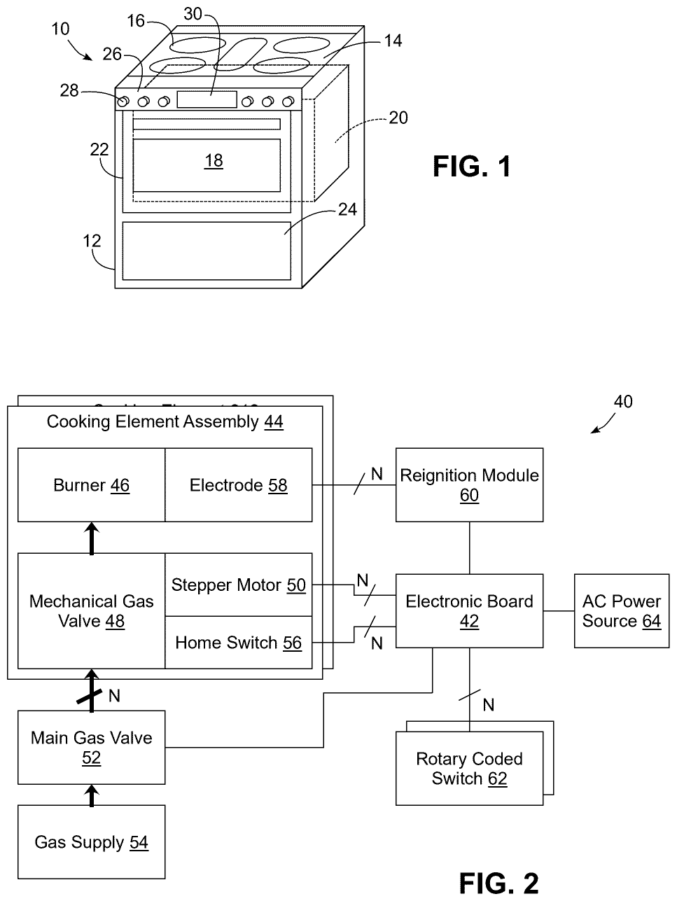

Turning now to the drawings, wherein like numbers denote like parts throughout the several views, FIG. 1 illustrates an example cooking appliance 10 in which the various technologies and techniques described herein may be implemented. Cooking appliance 10 is a residential-type range, and as such includes a housing 12, a stovetop or cooktop 14 including a plurality of burners 16, and an oven 18 defining an oven or cooking cavity 20 accessed via an oven door 22. Cooking appliance 10 may also include a storage drawer 24 in some embodiments, or in other embodiments, may include a second oven. Various cooking elements (not shown in FIG. 1) may also be incorporated into cooking appliance 10 for cooking food in oven 18, e.g., one or more electric or gas heating elements.

Cooking appliance 10 may also include various user interface devices, including, for example, a control panel 26 incorporating a plurality of rotary burner controls 28 and a user interface or display 30 for providing visual feedback as to the activation state of the cooking appliance. It will be appreciated that cooking appliance 10 may include various types of user controls in other embodiments, including various combinations of switches, buttons, knobs, and/or sliders, typically disposed at the rear or front (or both) of the cooking appliance. Further, in some embodiments, one or more touch screens may be employed for interaction with a user. As such, in some embodiments, display 30 may be touch sensitive to receive user input in addition to displaying status information and/or otherwise interacting with a user. In still other embodiments, cooking appliance 10 may be controllable remotely, e.g., via a smartphone, tablet, personal digital assistant, or other networked computing device, e.g., using a web interface or a dedicated app. In some embodiments, both the cooktop burners and the oven may be controlled by the same electronic control system, while in other embodiments, different control systems may be used for separate control of each system.

Displays 30 may also vary in different embodiments, and may include individual indicators, segmented alphanumeric displays, and/or dot matrix displays, and may be based on various types of display technologies, including LEDs, vacuum fluorescent displays, incandescent lights, etc. Further, in some embodiments, audio feedback may be provided to a user via one or more speakers, and in some embodiments, user input may be received via a spoken or gesture-based interface.

As noted above, cooking appliance 10 of FIG. 1 is a range, which combines both a stovetop and one or more ovens, and which in some embodiments may be a standalone or drop-in type of range. In other embodiments, however, cooking appliance 10 may be another type of cooking appliance, e.g., a cooktop, stovetop or hob lacking an integrated oven. In general, a cooking appliance consistent with the invention may be considered to include any residential-type appliance including a housing and one or more cooking elements disposed therein and configured to generate energy for cooking food.

In turn, a cooking element may be considered to include practically any type of energy-producing element used in residential applications in connection with cooking food, e.g., employing various cooking technologies such as electric, gas, light, microwaves, induction, convection, radiation, etc. In the case of an oven, for example, one or more cooking elements therein may be gas, electric, light, or microwave heating elements in some embodiments, while in the case of a cooktop, one or more cooking elements therein may be gas, electric, or inductive heating elements in some embodiments. Further, it will be appreciated that any number of cooking elements may be provided in a cooking appliance (including multiple cooking elements for performing different types of cooking cycles such as baking or broiling), and that multiple types of cooking elements may be combined in some embodiments, e.g., combinations of microwave and light cooking elements in some oven embodiments.

A cooking appliance consistent with the invention also generally includes one or more control circuits configured to control the cooking elements and otherwise perform cooking operations at the direction of a user. FIG. 2, for example, illustrates a control circuit implemented as an electronic control system 40 including an electronic board 42 that receives inputs from a number of components and drives a number of components in response thereto. Electronic board 42 may, for example, be configured to control a plurality of cooking element assemblies 44, which in the illustrated embodiment may each include a gas burner 46 regulated by a mechanical gas valve 48 that is actuated by a stepper motor 50. Each mechanical gas valve 48 is in turn coupled to a main gas valve 52 that regulates the flow of gas from a gas supply 54 to each cooking element assembly 44. Main gas valve 52 in some embodiments may be an electronically-controlled on/off valve (e.g., a solenoid valve) that is controlled by electronic board 42 and that is normally closed and actuated to an open position in response to a control signal from electronic board 42, such that gas flow is interrupted in the absence of a suitable control signal.

Mechanical gas valve 48 may include a rotatable valve actuator that rotates between a closed position at which gas flow is inhibited through the valve, and a fully open position at which gas flow is permitted through the valve. Mechanical gas valve may include a range of open positions to regulate the output level of the gas burner, and it will be appreciated that in many cooking appliance designs, the valve may include an output curve that progressively increases from the closed position, through an ignition range, and to a maximum operational output position, and then progressively decreases through an operational range to a minimum operational output position such that the maximum output position for the operational range of the valve is closer to the closed position than the minimum output position.

In addition, as will be discussed in greater detail below, a home position switch 56 is coupled to mechanical gas valve 48 and is configured to be mechanically engaged to indicate when the rotatable valve actuator is rotated to the closed position. By doing so, a positive verification of the closed state of the valve, and thus an off state of the associated gas burner, may be provided to electronic board 42.

Each cooking element assembly 44 also includes an electrode 58 disposed proximate burner 46 and coupled to an ignition module 60 that is in turn coupled to electronic board 42. Reignition module 60 may be configured to power electrode 58 to generate a spark to ignite burner 46 under control of electronic board 42. In addition, electrode 58 may also include a flame detector (or a separate flame detector may be used) to signal to reignition module 60 in response to detecting a flame loss (i.e., when no flame is detected from burner 46 after ignition has initially been achieved), such that a reignition process may be undertaken to attempt to reignite the burner, or to signal an error that causes electronic board 42 to close valves 48 and 52 when reignition is not successful after a predetermined number of attempts. Other manners of igniting and/or reigniting a gas burner may be used in other embodiments, and in some instances, module 60 may be an ignition module that lacks functionality for automatically reigniting a gas burner.

Control over each cooking element assembly 44 may be provided by an associated rotary coded switch 62, which as will be discussed in greater detail below, may be incorporated into a rotary burner control 28, e.g., a knob assembly, which is capable of switching rotary coded switch 62 between a plurality of discrete rotational positions. In other embodiments, however, other rotary controls, e.g., potentiometers, encoders, etc., may be used to support greater numbers of discrete positions and/or a continuous range of positions.

Power is supplied to electronic control system 40 from an AC power source 64 (e.g., 120 or 240 VAC line power), and electronic board 42 may include one or more power supplies configured to power each of the components in electronic control system 40.

Electronic control system 40 of FIG. 2 incorporates the functionality for controlling cooktop burners of cooking appliance 10. In some embodiments, electronic control system 40 may also control one or more oven cooking elements (which in some embodiments may be electric cooking elements rather than gas cooking elements) as well as other components in cooking appliance 10 (e.g., convection fans, lights, exhaust fans, etc.). In other embodiments, other control circuits may be used to control other components in cooking appliance 10.

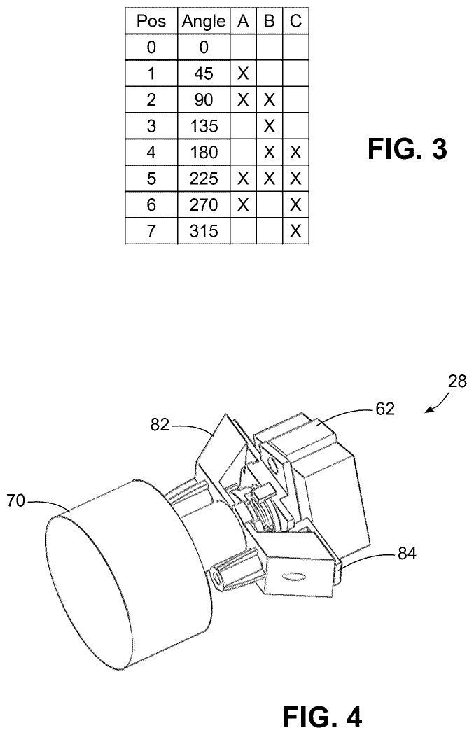

Now turning to FIG. 3, in the illustrated embodiment, each rotary coded switch 62 is configured to output a coded signal representing the current position of the switch among N discrete rotational positions. In the illustrated embodiment, for example, 8 switch positions, corresponding to 45 degree rotational positions, are provided, with switch 62 configured to output a unique three bit binary code of bits A, B, and C corresponding to the current switch position. It may be desirable in some embodiments, for example, to use a reflected binary code (RBC) or Gray code that changes only a single bit when transitioning between adjacent positions, which can avoid capturing spurious outputs that may arise due to the electromechanical nature of the switch (e.g., one bit may change a fraction of a second earlier than another one when transitioning between two positions). In other embodiments, however, other coded signals may be used, including natural binary signals. In addition, each rotary coded switch 62 in the illustrated embodiment includes a plurality of detents that maintain the rotary coded switch at specific discrete rotational positions, such that the rotary coded switch snaps between the discrete rotational positions, and is incapable of being released and maintained in any rotational positions that are intermediate the discrete rotational positions.

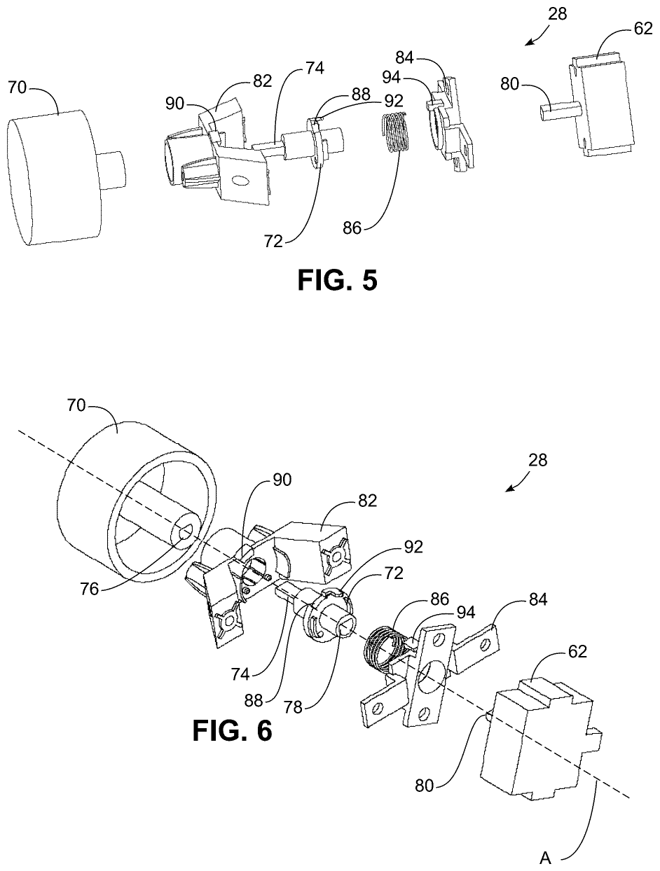

FIGS. 4-6 illustrate one example implementation of rotary burner control 28, which incorporates a control actuator 70, e.g., a knob, that is coupled to rotary coded switch 62 through an adapter 72 having a keyed shaft 74 that is press fit into a corresponding keyed opening 76 on a backside of control actuator 70, and that additionally includes a keyed opening 78 configured to receive a keyed shaft 80 of switch 62. Adapter 72 is secured between, and projects through apertures in, a support 82 and retainer 84 that are secured to switch 62 via fasteners (not shown). In addition, adapter 72 is movable along an axial direction A relative to the axis of rotation of switch 62 and control actuator 70, and biased away from switch 62 by a spring 86.

Corresponding structures on adapter 72, support 82, and retainer 84 implement a “push to turn” feature that requires a two step sequence, i.e., pushing control actuator 70 towards switch 62 and then rotating control actuator 70 in a counter-clockwise direction, in order to activate the associated cooking element assembly 44. In particular, a slot 88 on adapter 72 is configured to engage with a tab 90 on support 82 when switch 62 is in the off discrete rotational position and with spring 86 biasing adapter 72 away from switch 62, thereby resisting rotation of adapter 72 until control actuator 70, and thus adapter 72, are pushed inwardly along axis A to disengage tab 90 from slot 88. In addition, corresponding tabs 92, 94 on adapter 72 and retainer 84 are configured to restrict clockwise rotation of adapter 72 when switch 62 is in the off discrete rotational position, as well as to limit rotation of switch 62 beyond a maximum discrete rotational position (generally corresponding to the minimum operational output position for the mechanical gas valve). The aforementioned structure, which requires pushing in prior to turning the control actuator from the off position, reduces the risk of inadvertent turning of the control actuator as a result of bumping as well as activation by young children. It will be appreciated that other push to turn or two step activation structures may be used in other embodiments, so the invention is not limited to the specific construction illustrated in FIGS. 4-6.

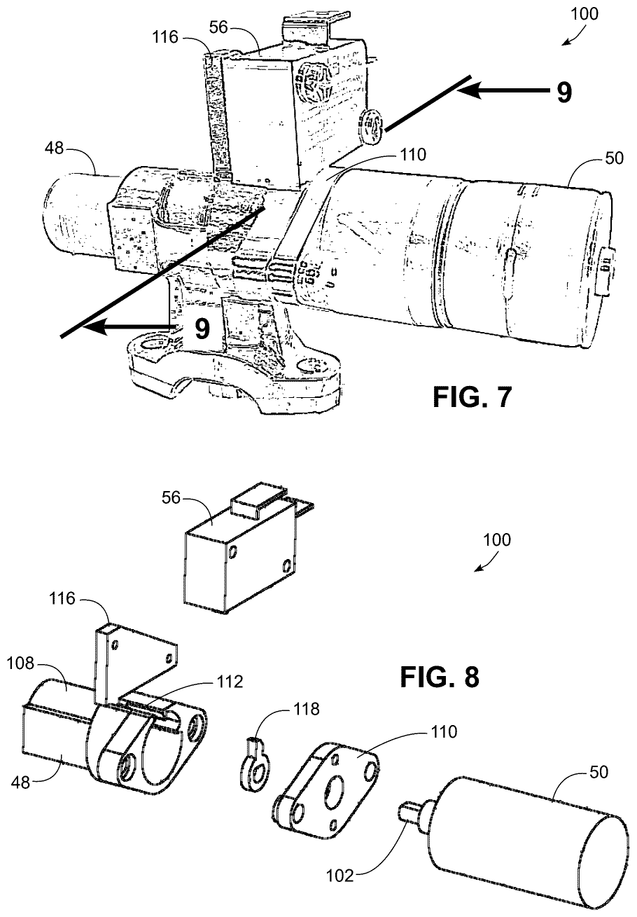

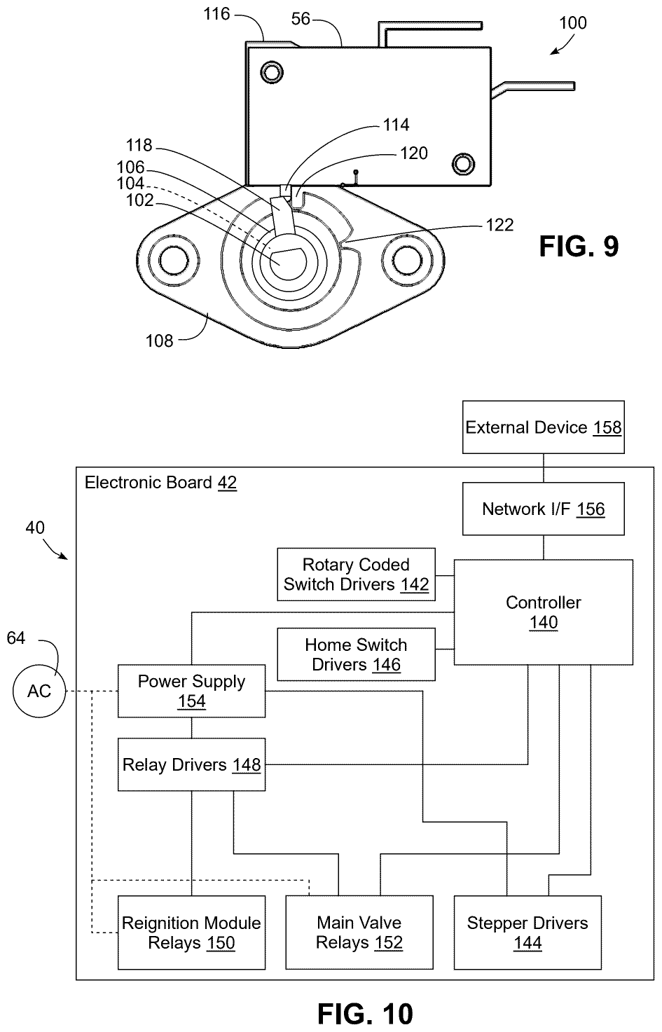

FIGS. 7-9 next illustrate one example implementation of a valve assembly 100 incorporating mechanical gas valve 48, stepper motor 50 and home position switch 56. Stepper motor 50 includes a keyed shaft 102 that is coaxial with and mechanically couples with a valve actuator 104 of mechanical gas valve 48 (see FIG. 9) such that shaft 102 of stepper motor 50 and valve actuator 104 of mechanical gas valve 48 are mechanically linked to one another to rotate together about a longitudinal axis of valve actuator 104. In some embodiments, for example, valve actuator 104 may include a keyed opening 106 that receives keyed shaft 102, while in other embodiments, a separate coupler body may be used. Stepper motor 50 is secured to a valve body 108 of mechanical gas valve 48 through a mounting plate 110, and a slot 112 is formed in valve body 108 to receive an actuator 114 (e.g., a depressible plunger) of home position switch 56, which is mounted to a bracket 116 formed on valve body 108. Other types of switches, e.g., lever switches, may be used in other embodiments.

A cam member 118 also includes a keyed opening and is received on shaft 102 of stepper motor 50 to rotate within an interior of valve body 108. As illustrated in FIG. 9, valve body 108 includes a pair of internal stops 120, 122 that are positioned within the path of rotation of cam member 118 to limit the rotation of valve actuator 104 between its off position and its minimum operational output position, respectively. Plunger 114 of home position switch 56, in turn, is positioned proximate internal stop 120 such that when stepper motor 50 rotates valve actuator 104 to its off position, as illustrated in FIG. 9, plunger 114 (which is biased to project inwardly through slot 112) is displaced in a radial direction relative to valve actuator 104.

In the illustrated embodiment, home position switch 56 is a normally open switch, such that home position switch 56 is closed only when valve actuator 104 is positioned in the off position. As such, combined with the mechanical coupling between the stepper motor shaft 102 and valve actuator 104, detection of switch 56 in a closed position provides positive verification that valve actuator 104 is physically in its closed position, and that valve 48 has been shut off.

FIG. 10 illustrates an example implementation of electronic board 42 of electronic control system 40 of FIG. 2. In this embodiment, a controller 140 is coupled to a number of drivers, including rotary coded switch drivers 142, stepper motor drivers 144, home switch drivers 146, and relay drivers 148. Rotary coded switch drivers 142 are coupled to the various rotary coded switches 62 corresponding to the different gas burners 46 to sense the position of each switch, while stepper motor drivers 144 and home switch drivers 146 are coupled respectively to the various stepper motors 50 and home position switches 56 to control the stepper motors to controllably rotate to different rotational positions of the respective valve actuators of the corresponding gas valves and to positively determine the open/closed state of each of the corresponding gas valves.

Relay drivers 148 are used to control a set of reignition module relays 150 that drive reignition module 60 and a set of main valve relays 152 that drive main gas valve 52. AC line power from AC power source 64 (represented by dashed lines in FIG. 10) is provided to relays 150, 152 as well as to a power supply 154. Power supply 154 provides one or more DC power signals (represented by solid lines in FIG. 10) to controller 140, as well as stepper drivers 144, main valve relays 152, and reignition module relays 150. Power supply 154 may provide multiple DC power signals, e.g., 5 and 12 VDC power signals, to power the various components in electronic control system 40, as will be appreciated by those of ordinary skill in the art having the benefit of the instant disclosure.

In addition, in some embodiments, electronic board 42 may also include a network interface 156, e.g., a wired and/or wireless network interface, to couple with one or more external devices 158, e.g., a computer, a mobile device, a cloud service, etc., thereby enabling remote access, and in some instances, remote control, to cooking appliance 10.

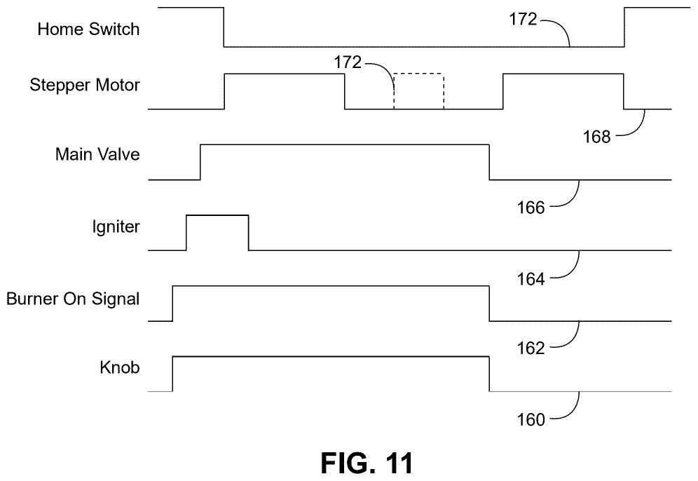

Now turning to FIG. 11, a timing diagram is illustrated to describe an example operation of a gas burner using electronic control system 40. As illustrated by line 160, assume that a user turns the knob away from the off discrete rotational position to an operating position (e.g., any of the other 7 positions selectable by rotary coded switch 62). Doing so generates a burner on signal (line 162) that causes controller 140 to signal reignition module 60 to activate the electrode 58 for the corresponding gas burner 46 and thereby generate a spark to ignite the burner (line 164). Shortly thereafter, controller 140 activates main gas valve 52 to allow gas flow to the mechanical gas valve 48 for the corresponding gas burner 46 (line 166), and thereafter activates the stepper motor 50 for the corresponding gas burner 46 (line 168) to open mechanical gas valve 48 and controllably rotate the valve actuator therefor to a predetermined rotational position. Of note, home position switch 56 is initially closed when mechanical gas valve 48, so when stepper motor 50 is activated to open the mechanical gas valve 48, this transition is indicated by home position switch 56, as illustrated by line 170.

Once a flame is detected by reignition module 60, electrode 58 is deactivated (line 164), and gas burner 46 is lit and in an operational state. During this time, a user may turn the knob to a different position corresponding to a different output level of the gas burner, whereby controller 140 activates stepper motor 50 (e.g., as illustrated at 172) to rotate the valve actuator of the gas valve 48 to a new rotational position.

Shutoff of the gas burner occurs in a similar manner. Rotation of the knob to the closed discrete rotational position (line 160) causes the burner on signal (line 162) to be deactivated, which causes controller 140 to deactivate main gas valve 52 (line 166) to interrupt the flow of gas to the mechanical gas valve 48, and the stepper motor 50 is activated to return the mechanical gas valve 48 to the closed position (line 168). When the mechanical gas valve 48 reaches the closed position, home position switch 56 is closed (line 172), thereby positively verifying to the controller that the mechanical gas valve is closed.

It will be appreciated that a desired rotational position of the valve actuator of mechanical gas valve 48 may be mapped to each discrete rotational position of the rotary coded switch 52 to effectively control the output level of the corresponding gas burner at each discrete rotational position of the switch. In some embodiments, the mapping may be determined empirically, and may be based in part on the burner size and characteristics, the flow characteristics of the gas valve, etc. In order to provide a similar experience to a conventional mechanically gas valve, for example, the first discrete rotational position counter-clockwise from the closed discrete rotational position may be mapped to a rotational position of the valve actuator that provides a suitable flow of gas for ignition of the gas burner, the next discrete rotational position may be mapped to a rotational position of the valve actuator that corresponds to a maximum output level of the gas burner, and each subsequent discrete rotational position may be mapped to a rotational position of the valve actuator that progressively lowers the output level until a last discrete rotational position provides a minimum output level for the gas burner. Other mappings may be used in other embodiments, however, so the invention is not limited to this specific mapping.

In addition, where a programmable controller is used in electronic control system 40, a stepper motor may be controlled to provide varying flows of gas and/or output levels during a cooking operation. For example, in some embodiments, a user may be able to activate a gas burner by turning the knob to a discrete rotational position corresponding to a desired output level, and the controller may initially control the stepper motor to rotate the valve actuator to an initial rotational position suitable for igniting the gas burner, and then when a flame is detected, activate the stepper motor a second time to rotate the valve actuator to the rotational position corresponding to the desired output level.

Furthermore, in some embodiments, customized cooking profiles may be used, whereby the controller controls the stepper motor to select different output levels for the gas burner at different points in a cooking operation. In addition, in some embodiments one or more positions of a rotary coded switch may correspond to a desired cooking profile that varies output levels over time and/or activates and deactivates a gas burner periodically. For example, in some embodiments one discrete rotational position of a rotary coded switch may correspond to a simmer cooking operation, whereby the gas burner is periodically cycled on and off (or between two different output levels) to generate a lower output level over time than can be achieved simply by rotating the valve actuator to the minimum output level position. Customized cooking profiles may also be created and/or selected through a user interface of the cooking appliance and/or via an external device (e.g., through a mobile app).

In still other embodiments, the controller may control the stepper motor and the main gas valve to automatically shut off a gas burner, e.g., after a predetermined time or in response to user control through an external device (e.g., through a mobile app), or to delay start a gas burner.

Other automated controls of the gas burner may be implemented using electronic control system 40, as will be appreciated by those of ordinary skill in the art having the benefit of the instant disclosure. Therefore, the invention is not limited to the particular controls described herein.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. A cooking appliance, comprising:
a gas burner;
a mechanical gas valve coupling the gas burner to a gas supply, the mechanical gas valve including a valve actuator rotatable between a closed position and an open position to regulate an output level of the gas burner, wherein when in the closed position the valve actuator shuts off a supply of gas to the gas burner;
a stepper motor mechanically coupled to the valve actuator and configured to controllably rotate the valve actuator between the closed and open positions;
a home position switch configured to be mechanically engaged to indicate when the valve actuator is rotated to the closed position;
a rotary coded switch rotatable between a plurality of discrete rotational positions and configured to output a coded signal indicating a current discrete rotational position among the plurality of discrete rotational positions, the plurality of discrete rotational positions including an off discrete rotational position; and
a control circuit coupled to the stepper motor, the home position switch, and the rotary coded switch and configured to control the stepper motor to rotate the valve actuator to a first predetermined position in response to selection of a first discrete rotational position among the plurality of discrete rotational positions of the rotary coded switch to control the output level of the gas burner, to control the stepper motor to rotate the valve actuator to the closed position in response to selection of the off discrete rotational position of the rotary coded switch, and to access the home position switch after controlling the stepper motor to rotate the valve actuator to the closed position to verify closure of the mechanical gas valve.

2. The cooking appliance of claim 1, wherein the stepper motor includes a shaft that is coaxial with and mechanically couples with the valve actuator.

3. The cooking appliance of claim 2, wherein the mechanical gas valve includes a valve body including a slot, and wherein the home position switch is coupled to the valve body and includes an actuator that projects into the slot.

4. The cooking appliance of claim 3, wherein the actuator of the home position switch comprises a depressible plunger.

5. The cooking appliance of claim 3, further comprising a cam member operably coupled to the valve actuator to rotate with the valve actuator within an interior of the valve body, the cam member further configured to actuate the actuator of the home position switch when the valve actuator is in the closed position.

6. The cooking appliance of claim 5, wherein the valve body further comprises first and second internal stops disposed in a path of rotation of the cam member to limit rotation of the valve actuator between the closed position and a minimum operational output position.

7. The cooking appliance of claim 1, wherein the home position switch is a normally open switch that is closed when the valve actuator is rotated to the closed position.

8. The cooking appliance of claim 1, wherein the rotary coded switch outputs a Gray code when rotating between the plurality of discrete rotational positions.

9. The cooking appliance of claim 1, wherein the rotary coded switch includes a plurality of detents, each configured to maintain the rotary coded switch at a respective discrete rotational position of the plurality of discrete rotational positions.

10. The cooking appliance of claim 1, further comprising a rotary burner control, the rotary burner control including a rotary control actuator coupled to the rotary coded switch to rotate the rotary coded switch in response to user input.

11. The cooking appliance of claim 10, wherein the rotary control actuator is coupled to the rotary code switch through an adapter that is movable along an axial direction relative to an axis of rotation of the rotary coded switch and biased away from switch.

12. The cooking appliance of claim 11, wherein the adapter is configured to engage a support of the rotary burner control when the rotary coded switch is in the off discrete rotational position and the adapter is biased away from the rotary coded switch to restrict rotation of the rotary control actuator away from the off discrete rotational position, and wherein the adapter is further configured to disengage from the support when the rotary control actuator is pushed toward the rotary coded switch to permit rotation of the rotary control actuator away from the off discrete rotational position.

13. The cooking appliance of claim 1, further comprising a main gas valve coupled in series with the mechanical gas valve and configured to regulate a flow of gas from a gas supply to the mechanical gas valve, wherein the control circuit is further coupled to the main gas valve and is configured to, during a cooking operation, maintain the main gas valve in an open position while controlling the stepper motor to control the output level of the gas burner.

14. The cooking appliance of claim 1, further comprising an ignition module configured to ignite the gas burner while gas is supplied to the gas burner through the mechanical gas valve.

15. The cooking appliance of claim 14, wherein the ignition module is a reignition module and is configured to attempt to automatically reignite the gas burner in response to detecting a flame loss.

16. The cooking appliance of claim 1, wherein the control circuit maps each of the plurality of discrete rotational positions of the rotary coded switch to a predetermined position of the valve actuator such that, in response to rotation of the rotary coded switch to a first discrete rotational position of the plurality of rotational positions, the control circuit controls the stepper motor to rotate the valve actuator to a first predetermined position mapped to the first discrete rotational position of the rotary coded switch.

17. The cooking appliance of claim 1, wherein the control circuit includes a programmable controller configured to operate the stepper motor to controllably rotate the valve actuator between at least two rotational positions during a cooking operation while the rotary coded switch is maintained in a first discrete rotational position.

18. The cooking appliance of claim 17, wherein the at least two rotational positions include a first rotational position suitable for igniting the gas burner, and a second rotational position corresponding to a desired output level of the gas burner during the cooking operation.

19. The cooking appliance of claim 17, wherein the programmable controller is further configured to control the stepper motor to automatically close the mechanical gas valve after a predetermined time.

20. The cooking appliance of claim 17, wherein the control circuit further includes a network interface configured to communicate with an external device, and wherein the programmable controller is further configured to control the stepper motor to automatically close the mechanical gas valve in response to user input from the external device.
